(19) United States
(12) Patent Application Publication
(10) Pub. No.: US 2008/0247930 A1
(43) Pub. Date: Oct. 9, 2008

(54) Nano-fusion reaction

(76) Inventor: Robert Hotto, Carlsbad, CA (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 11/725,604

(22) Filed: Mar. 17, 2007

Related U.S. Application Data
(60) Provisional application No. 60/783,585, filed on Mar. 18, 2006.

(51) Int. Cl. C01B 23/00; G21B 1/03; B01J 19/08

(52) U.S. Cl. 423/262; 376/103; 376/102; 423/445 B; 423/447.2; 977/842; 977/734; 977/750; 977/752

(57) ABSTRACT

A nano-fusion reactor comprised of nano-particles such as carbon based nanotubes, endohedral fullerenes and other nano materials encapsulating fusible fuels such as the hydrogen isotopes, deuterium, and tritium. The nano-devices encapsulate the fusible materials and ignite fusion reactions which in some of the embodiments consume the nano-fusion reactor device requiring the replenishment of these devices so to continue the fusible reactions. The reactions can be controlled and scaled through modulated presentation of fusion targets to the ignition chamber. The fusion reactions are ignited in the embodiments through one or more of the applied forces in the fusion reactor: electromagnetic compressive, electrostatic, and thermo. These applied forces in conjunction with the extreme structural strength, the ablation forces and purity of the nano-fusion device produces maximum forces necessary for the production of a shock wave on the nano-encapsulated device to ignite one or a plurality of fusion reactions. The lower ignition energy is due to a smaller device with less fuel, more efficient coupling of applied energy by the nano-device, along with purer encapsulated fuels, and improved geometries has provided improvements over conventional ICF reactions.

### CROSS REFERENCE TO RELATED APPLICATIONS

This application claims the priority benefit and full Paris Convention rights of United States provisional patent application Ser. No. 60/783,585 filed Mar. 18, 2006.

### BACKGROUND OF THE INVENTION

1. Field of the Invention

The present invention relates to controlled fusion reaction devices, processes and products. More particularly, the present invention is directed to a fusion fuel container for use in a fusion reactor system.

2. Description of Related Art

Magnetic and inertial confinement approaches to fusion can be compared to and are related to explosion by Coulomb forces of deuterium clusters and ultra-fast laser-plasma mechanisms. This is known as “the UCLA approach”. Fusion likewise has been reported via heating of pyroelectric crystals in a deuterated atmosphere.

According to the UCLA approach, a deuteron beam (>100 KeV and >4 nA) is accelerated by means of the electrostatic field which the crystal generates and is responsible for a neutron flux in excess of 400 times the background level. Proton recoil spectroscopy and pulse shape analysis confirm that neutrons are present and compliance with a following equation is exhibited

−[D+T→³He(820 KeV)+n(2.45 MeV].

It was likewise demonstrated by the UCLA approach that the predicted delayed coincidence existed between the outgoing a particle and the neutron wherein minute (centimeter scale) pyroelectric crystals are used to generate ion beams having energy and current effective to drive nuclear fusion reactions. See United States Provisional Patent Application Ser. No. 60/783,585, filed Mar. 18, 2006, expressly incorporated herein by reference, as if fully set forth.

It is accepted among those skilled in the art that high temperature, high pressure, sustained reactions and output are needed for a fusion type of reaction to transform mass into energy. According to the instant disclosure, isotopes of hydrogen are most commonly used to combine deuterium with tritium, to yield an alpha particle, the common isotope of helium-4, and a fast neutron yielding energy.

Expressly incorporated herein by reference, as representative of the state of the art are the following United States Letters Patents, U.S. Pat. Nos.: 7,002,169; 6,986,876; 6,979,709; 6,969,504; 6,960,869; 6,939,525; 6,936,953 6,593,539; 6,418,177; 6,361,747; 5,968,323; and 5,043,131.

In the fusion process, releasing sustained energy is driven by high speed collisions, overcoming the repulsion of the positive charges causing the nuclei to fuse. What has been enumerated as a longstanding need is apparatus to allow deuterium-tritium fuel to be heated and confined so that the binding energies released in fusion reactions which are achieved are of greater magnitude than energy expended in the reaction.

It is believed that nanostructures may be utilized in this application. Carbon nanotube structures are disclosed in United States Letters Patents Nos. U.S. Pat. Nos. 6,939,525; 6,936,953; 6,979,709; 6,969,504; and 6,986,876. Since their discovery in 1991, carbon nanotubes have challenged scientists to characterize the scope and depth of their numerous interesting properties. Carbon nanotubes may essentially be described as graphene sheets rolled up into the shape of a cylinder. The resulting graphene cylinders are about 1-2 nanometers in diameter, capped with ends containing pentagonal rings.

The arc-discharge methodology has been able to produce large quantities of multi-walled nanotubes, typically greater than 5 nanometers in diameter, which have multiple carbon shells in a structure resembling a series of enclosures of descending scale, for example like that of a “Russian doll.” In recent years, single-walled nanotubes using this method have been grown as well and have become available in large quantities. The laser ablation method of carbon nanotube growth has produced single-walled nanotubes (SWNT) of excellent quality, but requires high-powered lasers while producing small quantities of material. The CVD method was pioneered by (Nobel Laureate) Richard Smalley at Rice University and has now yielded substantial results.

The CVD growth technique has been supplemented with use of well known inorganic chemicals specifically, involving the formation of highly efficient catalysts of transition metals to produce primarily single-walled nanotubes. As discussed, MWNT and clusters of the same in combination with endohedral fullerenes like support and also teachings of the present invention.

Multi-walled (MWNT) and single-walled nanotubes (SWNT) have similar properties and for illustrative purposes, herein, focusing on single-walled nanotubes provides a reasonable basis for the background discussion, those skilled understand both types are contemplated, and fall within the scope of the instant disclosure. Unprecedented nanotube properties include strength, high elasticity, large thermal conductivity and current density. Several reports have determined that SWNT have a strength of between 50 and 100 times that of steel.

The elasticity of SWNT is 1-1.2 terrapascal (TPa), a measure of the ability of a material to return to its original form after being deformed. This means a molecule that is as strong as steel, but flexible like a rubber band on the atomic scale. Despite these structural properties, SWNT has a thermal conductivity close as great at twice that of diamond, known to be one of the best conductors of heat. Perhaps one of the most impressive properties of SWNT involves their electrical conductivity which is reported to be approximately 10° Amps per square cm, which is roughly 100 times that reported in copper, the conductor of choice for nearly every electrical device in common use today.

SWNT generally have two types of structural forms, which impart an additional set of electrical characteristics. Depending upon the alignment of the carbon atoms in the cylindrical form, SWNT can be either archiral, having atomic uniformity along its axis or chiral, having a twisted alignment from the uniform case. Achiral and chiral forms can act like metals or semiconductors and yet retain the same basic nanotube structure, function and emergent set of technologically compelling, inherent characteristics.

In addition to these well known properties, SWNT also have some additional features which make them more interesting as tools. SWNT have a density approximately half that of aluminum, making them an extremely light material. SWNT are stable at temperatures up to 2700° C. under vacuum, which is impressive, considering that the melting point of Ruthenium, Iridium and Niobium metals are within the range of that temperature. These atoms can be derivatized to alter the structure of the SWNT, allowing their properties to be tailored, or further customized. For example, one application for which SWNT are particularly useful is the arena of electronics, specifically to create non-volatile memories. In the case of non-volatile memory applications significant progress has been made in using “fabrics” or assemblages of SWNT as electrical traces within integrated circuits. These fabrics retain their molecular-level properties, while eliminating the need for nano-scale physical control. Called “fabrics”, these monolayers are created by room temperature spin-coating of a solution of single-walled nanotubes (SWNTs) in a semiconductor grade solvent.

The CVD method, and a recent alternative Plasma Enhanced Chemical Vapor Deposition (PECVD), have become more prominent as the method of choice for producing large quantities of SWNT, with micron lengths and purity and reliability within specifications for certain applications. PECVD has been reported to lower the temperature of nanotube growth significantly by using a plasma to generate the reactive carbon atoms, instead of very high temperatures as in standard CVD growth. Such production techniques may be preferable for fabrication and growth of nano-carbon fullerenes and nanotubular structures that are particularly useful in the present invention as further described in detail below.

### SUMMARY OF THE DISCLOSURE

Briefly stated, endohedral fullerenes, clusters of the same, carbon nanotubes and the like nano-devices house hydrogen isotopes as targets presented to, and manipulable about a reactor system which re-circulates and recaptures both useful products and ash. A nano-fusion reactor comprised of nano-particles such as carbon based nanotubes, endohedral fullerenes and other nano devices encapsulating fusible fuels such as the hydrogen isotopes, deuterium, and tritium. The nano devices encapsulate the fusible materials and ignite fusion reactions and consume the nano-fusion devices requiring the replenishment of these devices to the plant so to continue the fusible reactions. The reactions can be controlled and scaled through fusible target material presentation the ignition chamber. The nano-fusion reactions are ignited in the embodiments through one or more of the generated forces. These in situ generated forces in conjunction with the extreme structural strength and hardness of the nano-fusion targets produces maximum forces necessary for the production of a shock wave impinging directly on the nano-encapsulated materials necessary to ignite fusion reactions. Lower ignition energy and more efficient use of coupling is energy efficient to generate improvements over conventional ICF reactions.

According to a feature of the present invention, there is provided at least a nano-device encapsulating hydrogen isotopes. In particular, a nano-fusion target encapsulating deuterium and tritium is offered for consideration.

According to another feature of the present invention there is provided a device for directing energy to nano-devices encapsulating fusible fuels.

According to yet another feature of the present invention there is provided an inertial confinement fusion process which comprises, in combination, a plurality of nano-devices encapsulating deuterium-tritium fuel.

According to yet still another feature of the present invention there is provided a device for producing endohedral fullerenes encapsulating deuteriums and tritium.

According to yet still another and further feature of the present invention, there is provided a device for igniting nano-devices encapsulating deuteriums and tritium and employing byproducts of the reaction for breeding nano-devices encapsulating deuteriums and tritium to further continue the fuel ignition and breeding cycle.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1A is a schematic of deuterium and tritium fuel pellets caged within a nano-device, such as an endohedral fullerene in a metal ignition shell;

FIG. 1B shows a schematic of a “ball and stick” model of a fullerene structure, prior to endohedralization and encapsulation of hydrogen isotopes according to the present invention;

FIG. 2 shows an assembly for fuel production/plant and the related system elements according to embodiments of the present invention;

FIG. 3 likewise illustrates schematically an ignition chamber/plant according to embodiments of the present invention;

FIG. 4 demonstrates endohedral fullerenes generation mechanisms, according to the teachings of the present invention;

FIG. 5 demonstrates endohedral fullerenes generation mechanisms, according to the teachings of the present invention;

FIG. 6 demonstrates endohedral fullerenes generation mechanisms, according to the teachings of the present invention;

FIG. 7 demonstrates endohedral fullerenes generation mechanisms, according to the teachings of the present invention;

FIG. 8 demonstrates endohedral fullerenes generation mechanisms, according to the teachings of the present invention;

FIG. 9 demonstrates endohedral fullerenes generation mechanisms, according to the teachings of the present invention;

FIG. 10 demonstrates endohedral fullerenes generation mechanisms, according to the teachings of the present invention;

FIG. 11 demonstrates endohedral fullerenes generation mechanisms, according to the teachings of the present invention;

FIG. 12 demonstrates endohedral fullerenes generation mechanisms, according to the teachings of the present invention;

FIG. 13 shows prior art including ICF with conventional laser irradiation;

FIG. 14 shows cluster arrangement of endohedral fullerenes and/or single or multi-walled nanotubes, according to the teachings of the present invention;

FIG. 15 schematically illustrates peaks of lasers and at least one of endohedral fullerenes and single-walled or multi-walled carbon nanotubes, according to the teachings of the present invention.

### DETAILED DESCRIPTION

Disclosed is inertial confinement fusion systems employing nano-devices, in contrast to millimeter-scale pellets of the prior art, affording additional enabling capabilities such as improved energy coupling with ignition drive. Lower ignition energy requirements, and the ability to provide additional nano structures for enhancing and enabling energy coupling to the nano encapsulating device in order to facilitate fusion reactions render the instant teachings useful. Such devices or structures on the surface of a nano-device for improving the shockwave and implosion including structures such as endohedral fullerenes with a plurality of walls and/or single or multi-walled nanotubes embedded in a cluster for providing control of fusion flame propagation address longstanding needs.

The present inventor is disclosing that nano-devices in fusion plants that can be used to accomplish various improvements, based upon inherent characteristics of endohedral fullerenes, and other nano-devices and articles in light of the ongoing needs.

Major issues within the nano-world are solved by the instant disclosure including a major concern yet to be overcome, e.g. the need for energy amplification, to yield more energy then expended in the reaction.

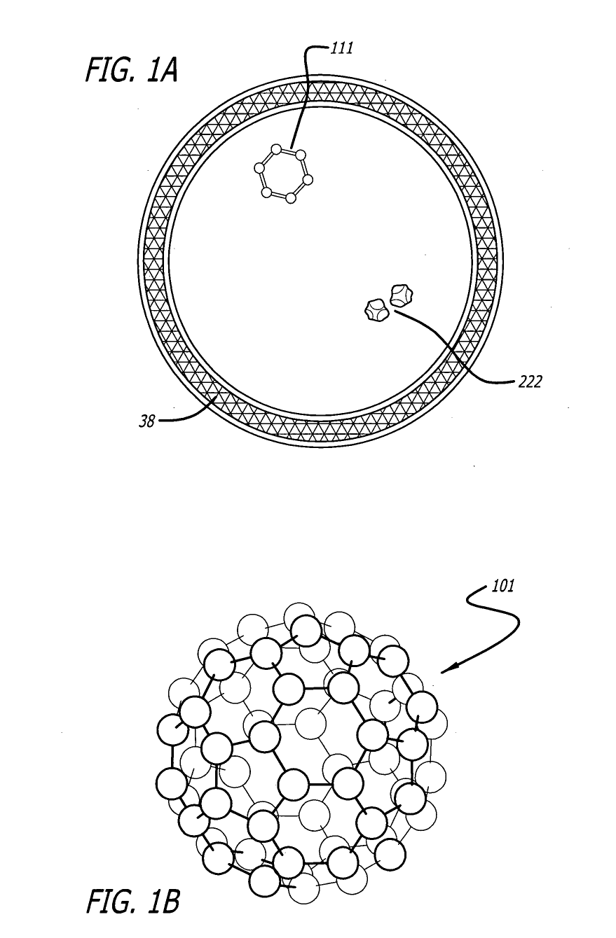

Turning now to FIG. 1, for example endohedral fullerene structure 111 is surrounded optionally by metal ignition shell 38, in one configuration whereby the encapsulated fuels 222 comprise deuterium 111 according to the embodiments of the teachings of the present inventor. The present invention does not require the metal ignition shell 38.

In essence, fusion targets/pellets/fuels 222 are presented to the fusion chamber within which said targets, based upon the use of electro magnetic energy whereby the inertial confinement fusion targets are ignited driving the desired reactions. This is done as the outer shell and some of the fuel is ablated and hydrogen isotopes inside targets 222 implodes inward becoming denser. Meanwhile it is required to heat the fuel and compress the fuel by the motion of the inward moving part of the pellet. This process is based on inertial confinement fusion but employing nano-devices and benefits from features afforded by the nano-devices such as inherent nano-lasers, devices such as clusters of nano-devices with a single shell or a plurality of shells.

Ablating carbon in a carbon arc in a deuterium and tritium rich atmosphere produces endohedral fullerenes in target breeder chamber 300. Endohedral fullerenes are sorted by device 338 discarding by-products out of exit 342. Likewise, carbon arc 107 is disposed within fuel production chamber 300 proximate to deuterium input 202, across from tritium input 201. Controller 103 determines the rate of pellet injection, and controls the reaction by modulating speed of injection of fusion targets in combination with sensors 105 in the coil system (conventional and known to those skilled in the art). Fusion target output 303 is located along conduit 305 separated by valve 309, which is likewise linked to controller 103 which is in communication with sensor 105. Device is further ported by valve 311 and abuts storage and discharge area 300 which ejects fusion targets 222 as controlled by valve 315. It is likewise contemplated that CVD and PECVD processes, and both known and developed chemical processes for fullerene generations are expressly within the scope of instant teachings, and part of the present inventions as recognized by Artisans.

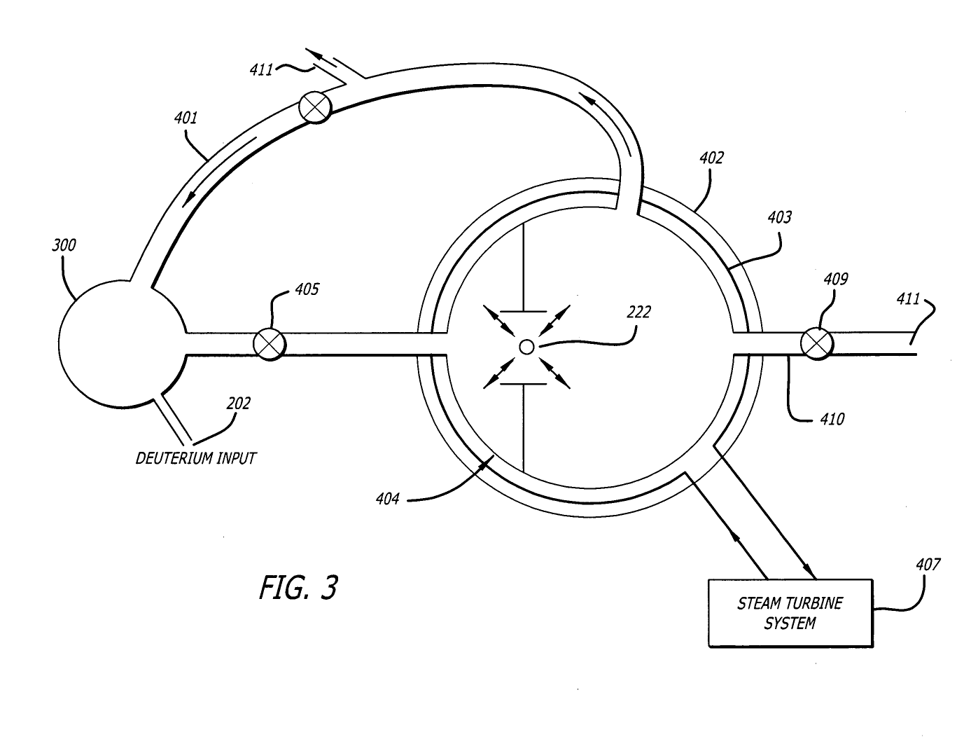

Referring now also to FIG. 3, fuel production chamber 300 has tritium input 401 from reaction of the lithium blanket, 402 with the fusion by-products with the endohedral fullerene fuel pellets 222. The liquid lithium blanket 402, as is known to those skilled in the art protects the chamber and captures the heat from the fast neutron and heat extraction coils 403. The lithium blanket also reacts with the fusion by-products to produce the tritium which is harvested for use in the breeder chamber, 300. The sensors not shown as conventional, are linked to steam turbine system 407. Valve 409 controls pathway 410 to the extraction port 411, while valve 405 is disposed between fuel production chamber 300 and ignition chamber 404. Supplemental assembly chamber 307 is effective for assembling clusters of fusion targets. It likewise is known to add other elements to fusion pellets and other materials. Lithium, for example, may be used according to the instant teachings as may any other elements that are required to make the reaction run better.

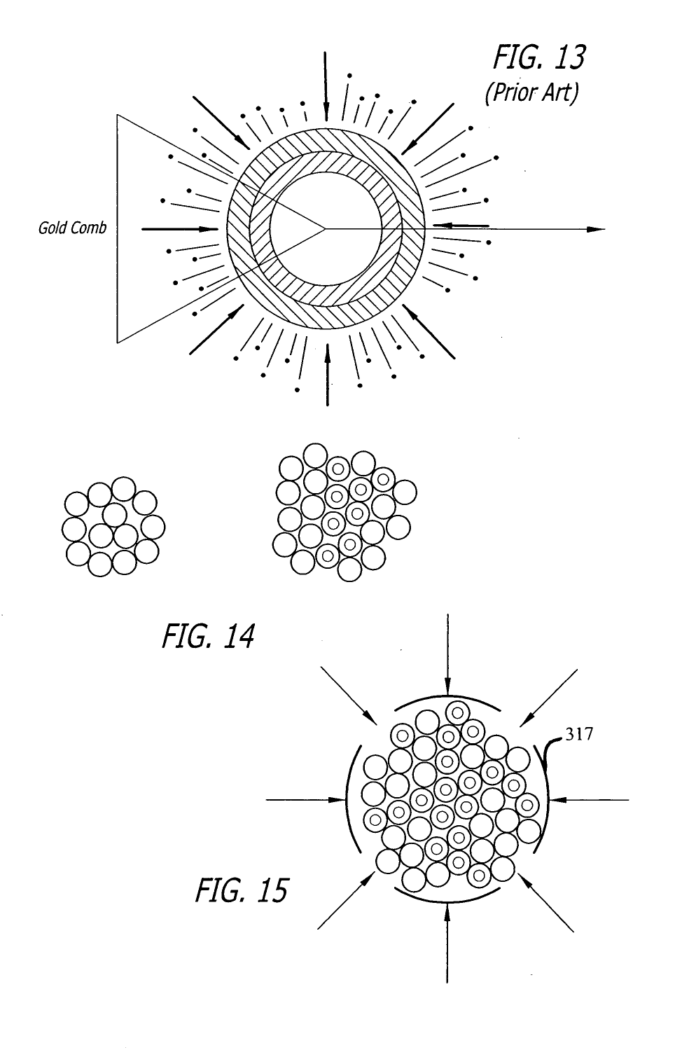

Deuterium-tritium endohedral fullerenes, single or multi-walled nanotubes incorporating hydrogen isotopes are presented to ignition chamber 404 and ignited by the drive system causing fusion with the yield of energy and the by-production of the fusion reacting with the lithium blanket which produces tritium. Valves 409, 405 and outlet 411, operate such that exhaust from the reaction is fed back into the breeder chamber 300 providing the deuterium and tritium rich atmosphere to further breed nano-device targets 222, which are then fed into the fusion chamber. This continues the cycle and provides energy amplification which is absorbed by the lithium blanket and provides useful energy. In contrast, conventional ICF reactors require targets to be manufactured in a temporally extended (sometimes weeks long process) the instant process is a self-feeding flow reaction. Likewise, laser direct drive or indirect drive by laser hohlraum as is known to those skilled in the arts and is used in conjunction with the present invention as shown for example in FIG. 13 and 15.

Another method is comprised of steps for opening an orifice of the surface of fullerenes, insertion of a small atom or a molecule through the orifice, and closure of the orifice, making use of rational techniques of organic synthesis. In this way, the efficient production of various endohedral fullerenes in a much larger amount is expected.

As the first step of the molecular surgery approach, Wudl and co-workers pioneered an efficient route to open an 11-membered ring orifice on the surface of C₆₀ (1). However, even a small atom, such as helium, was found to be difficult to pass through this orifice. Subsequently, several open-cage fullerene derivatives with a relatively large orifice have been reported. Rubin and co-workers, for instance reported the synthesis of cobalt(III) complex 2, whose cobalt atom was ideally locate above a 15-membered ring orifice, but the insertion of this metal atom into the C₆₀ cage through the orifice was not possible even by application of such high pressure at 40,000 atm in a solid state.

A great progress in this research field was brought about again by Rubin's group, who found an elegant strategy to synthesize open-cage fullerene derivatives 3 with a 14-membered ring orifice. Although the shape of the orifice is rather elliptic, the second step of the molecular surgery was first achieved using 3, that is, insertion of a helium atom (1.5% yield) or a hydrogen molecule (5% yield) in the hollow cavity of 3 through the orifice under the conditions of 288-305° C./ca. 475 atm and 400° C./100 atm, respectively. Recently, Iwamatsu and co-workers reported a fullerene derivative 4 with a surprisingly huge orifice, with its molecular shape almost looking like a bowl, and showed that a water molecule can get inside the cage even at room temperature under a normal pressure.

Likewise, effective according to the present invention is yet another process using complete closure of the orifice of H₂@5 by four-step organic reactions to afford an entirely new endohedral fullerene, H₂@C₆₀ and its properties are supportive of the instant teachings. So far, the NMR chemical shift of ³He incorporated in fullerenes, albeit in a small amount (0.1^{2b} to 1%¹⁸), has been successfully used as a probe sensitive to the structure of fullerenes. Similarly, the endohedral H₂ chemical shifts should be highly sensitive to the fullerene structure, and this has been also examined in detail for a series of open-cage fullerene derivatives incorporating H₂ as well as some of the derivatives of H₂@C₆₀.

This result indicated that it is necessary to reduce the size of the orifice in order to produce H₂@C₆₀ without a serious loss of the encapsulated hydrogen. At first glance of the molecular structure of 5, removal of a sulfur atom appeared as the most facile procedure for the orifice size reduction. It is necessary to first conduct an oxidation of the sulfide unit of H₂@6 quantitatively.

Between the two possible steroisomers, H₂@6(exo) and H₂@6 (endo), the exo-isomer is considered to be formed since it can avoid steric repulsion between the sulfinyl group and two carbonyl groups. Indeed the exo-isomer to be more stable than the endo-isomer by 8.6 kcal mol⁻¹. The ¹H NMR spectrum of H₂@6 showed a sharp signal for the encapsulated hydrogen at δ=−6.33 ppm in o-dichlorobenzene-d₄ (ODCB-d₄), which is 0.92 ppm downfield shifted compared to that of H₂@5 (δ=−7.25 ppm), with the integrated peak area of 2.0±0.02 H.

To chemically remove the SO unit, steps of removing its thermal extrusion by heating H₂@6 in refluxing toluene or at 140° C. in ODCB were attempted, but there was practically no reaction. In contrast, simple irradiation of a solution of H₂@6 in benzene with visible light through a Pyrex glass flask by the use of xenon lamp at room temperature afforded desired product H₂@7 in 42% yield (Scheme 1b), with 38% recovery of unreacted H₂@6.

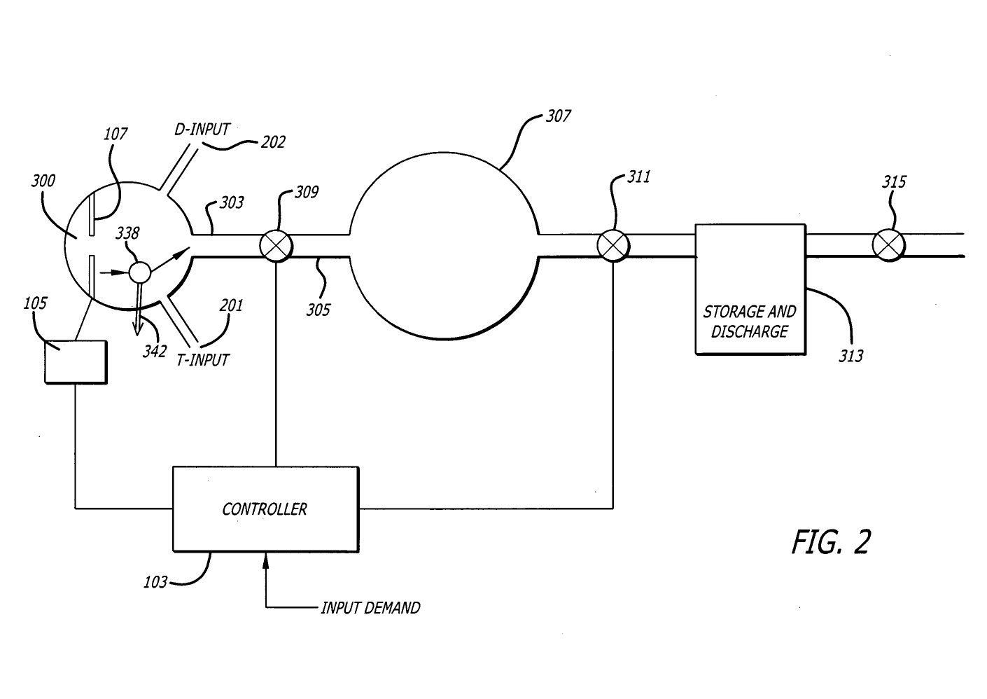

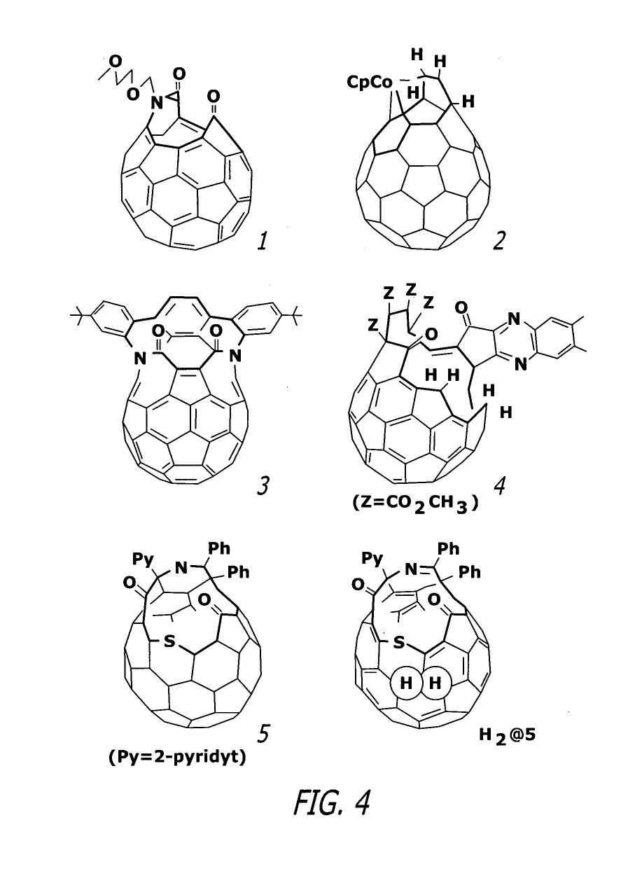

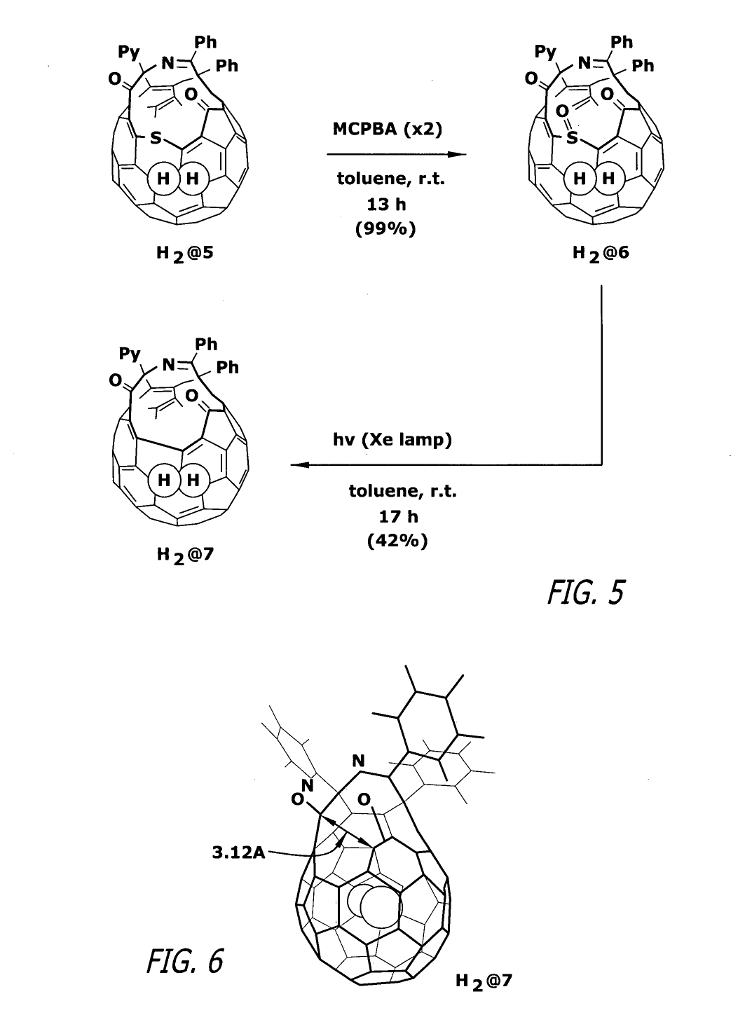

Referring now to sub-creations depicted in FIG. 4 and sub-figure 2, removal of the sulfur atom from the 13-membered ring orifice of H₂@5 brought about a significant size reduction of the orifice. The distance between two carbonyl carbons across the orifice is reduced from 3.89 A for H₂@5 to 3.12 A for H₂@7. Accordingly, the calculated activation energy for the escape of the hydrogen molecule from H₂@7 is estimated at 50.3 kcal mol⁻¹, which is significantly greater than that of 28.7 kcal mol⁻¹ for H₂@5²⁴ (both calculated at the B3LYP/6-31 G** level with optimized structures at the B3LYP/3-21 G level.)

In fact, no escape of any encapsulated hydrogen was detected at all upon heating an ODCB-d₄, which was heated in a sharp contrast with the case of H₂@5, from which the hydrogen molecule was gradually released with the half-life period of 4.2 h under the same conditions.

Unfortunately, however, the spectrum showed that about 20% of the hydrogen molecule escaped during the transformation to C₆₀ upon laser irradiation. As a preliminary study, the powder of H₂@7 was heated at 350° C. under vacuum (ca. 1 mmHg), but this resulted in the formation of H₂@C₆₀ only in a trace amount. Hence the further reduction of the orifice size was apparently required to produce a macroscopic amount of H₂@C₆₀.

For this purpose, the McMurry reaction worked efficiently for reductive coupling of the two carbonyl groups at the orifice of H₂@7, leading to the formation of open-caged fullerene derivative H₂@8 with an eight-membered ring orifice in 88% yield. The high efficiency of this reaction is quite reasonable since the two carbonyl groups of H₂@7 are fixed at the parallel orientation in a close proximity, as mentioned above.

It is to be noted that the encapsulated hydrogen was completely retained at each step of the process for orifice size reduction, which was confirmed by comparing the integrated peak area for the encapsulated hydrogen with reference to that for the aromatic protons in each ¹H NMR spectrum.

The final step to completely eliminate extra organic addends and to close the orifice was accomplished by heating a brown powder of H₂@8 (245 mg) in a vacuum-sealed tube placed in an electric furnace at 340° C. for 2 h. The resulting black material completely dissolved in carbon disulfide (CS₂) and was analyzed by HPLC on a Cosmosil Buckyprep column eluted with toluene.

Theoretical calculations as well as inspection of the molecular model suggests that it is impossible for a hydrogen to pass through that cleavage of some additional single bonds in the fullerene skeleton of H₂@8 (not shown in FIG. 6) also takes place at a temperature higher than 300° C., which instantaneously opens a window to release a small portion of the encapsulated hydrogen.

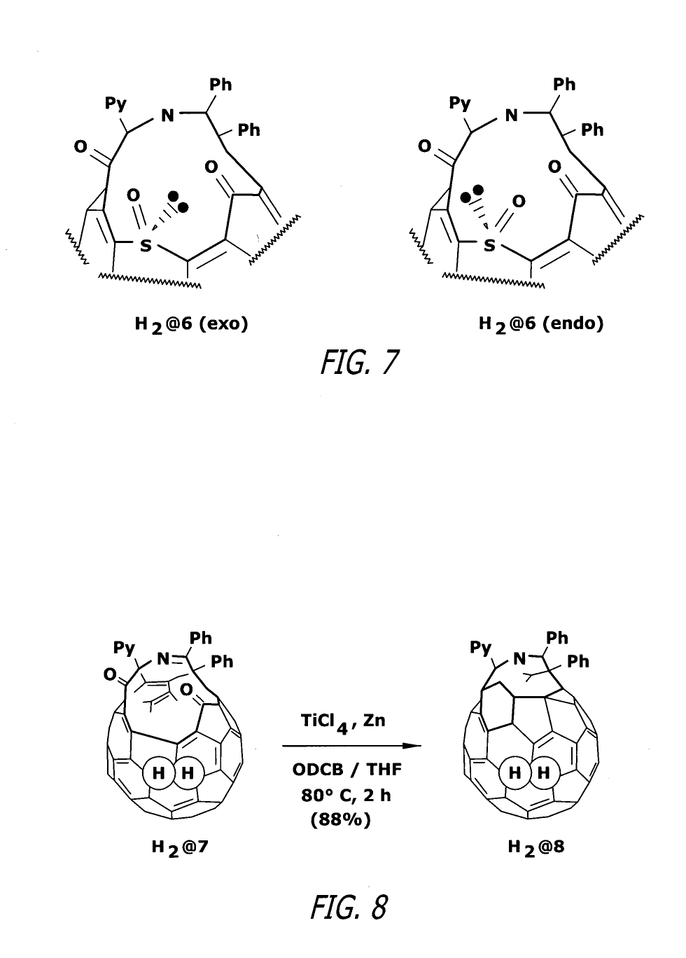

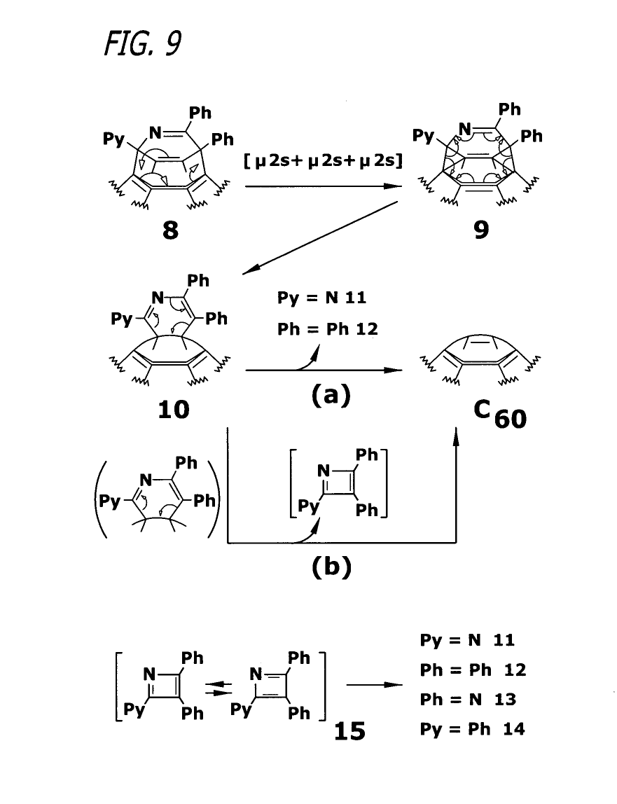

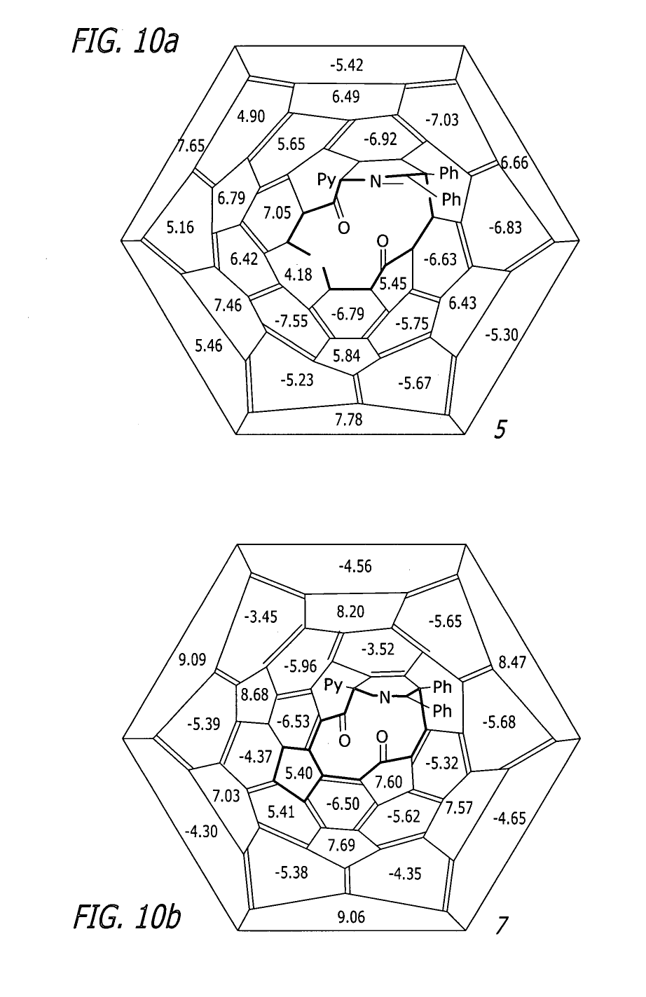

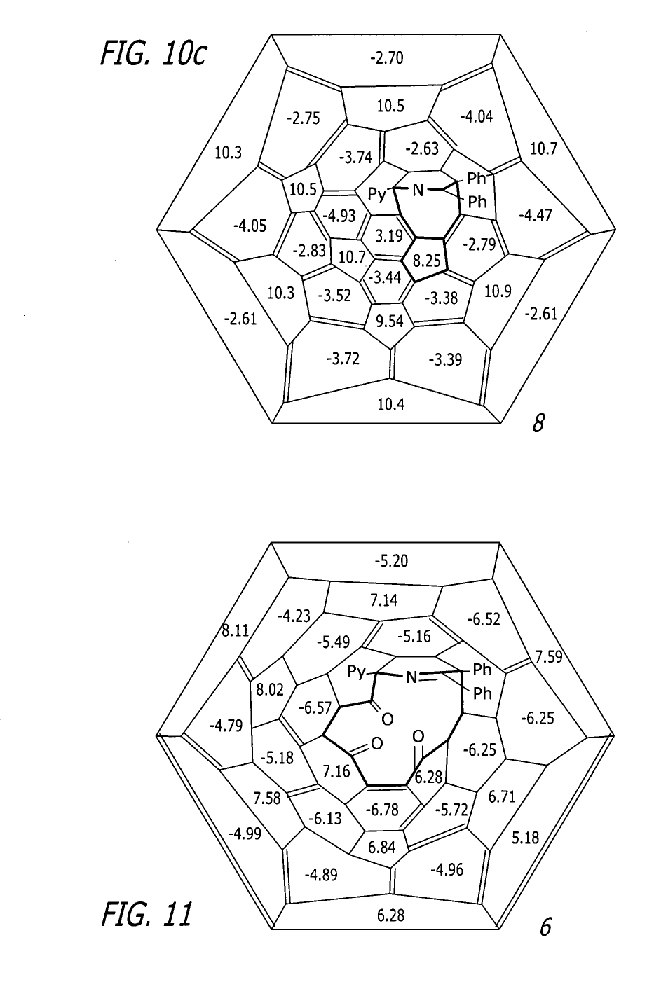

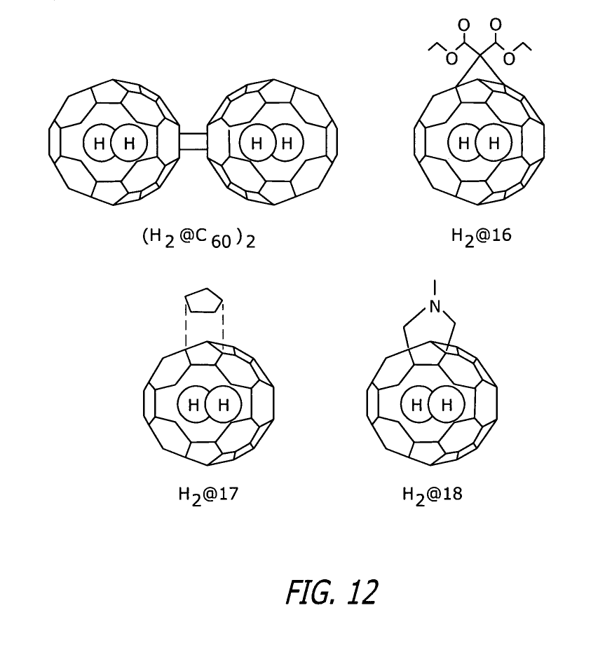

Although the desired product of the thermal reaction, H₂@C₆₀, was contaminated by 9% of empty C₆₀, the purification of H₂@C₆₀ was achieved by recycling HPLC on a semipreparative Cosmosil Buckyprep column (as shown in FIG. 7.) After 20 recycles H₂@C₆₀ was completely separated, with its total retention time being 399 min, while that of C₆₀ was 395 min. The adsorption mechanism of the Buckyprep column is based on a π-π interaction with the pyrenyl groups in the stationary phase. Therefore, a very weak but appreciable van der Waals interaction must be operating between the inner hydrogen molecule and the π-electron cloud of outer C₆₀, and this must have contributed to this separation.

The endohedral fullerene H₂@C₆₀ is thermally stable. Upon heating the pure sample of H₂@C₆₀ at 500° C. for 10 min under vacuum, there was no decomposition or release of incorporated hydrogen at all, as judged from the ¹³C NMR and HPLC.

The observed gradual downfield shift must be due to the change in magnetic environment of this hydrogen, resulting from the change in diamagnetic and paramagnetic ring currents, of the fullerene cage.

A similar trend is also seen in the case of the chemical transformation of 7 to 8, which caused further downfield shift by 2.85 ppm (calculated value, 3.68 ppm). In this way, the size reduction of the orifice in each step is shown to lower the aromatic character of the fullerene cage as a whole.

A series of these orifice size reduction processes should also be accompanied by very slight but gradual increase in strain of the fullerene's σ-frameworks, which should gradually weaken the extent of the total π-conjugation of the fullerene surface.

These are all taken together as the reason for observed downfield shifts upon the reduction of the orifice size. In a final step, in which the organic addends were completely removed and the original C₆₀ structure was restored from H₂@8, 1.50 ppm downfield shift was observed. Again, the pyramidalization of all 60 carbons and the resulting increase of strain should be related to the lowering of the overall aromaticity. In addition, this last step is accompanied by the formation of two fully π-conjugated antiaromatic pentagons compared to 8. All of these effects are assumed to be added together to cause the downfield shift of the H₂ NMR signal.

To examine the effect of encapsulated hydrogen upon the reactivity of the outer fullerene cage, the solid-state mechanochemical dimerization of H₂@C₆₀ was conducted.

It was found that the dumbbell-shaped dimer, (H₂@C₆₀)₂ was obtained in 30% isolated yield similarly to the reaction of empty C₆₀. Apparently, the inside hydrogen does not affect the reactivity of the outer C₆₀ cage. The NMR signal for the inside hydrogen was observed as a singlet at σ-4.04 ppm, which is 8.58 ppm upfield shifted from free hydrogen, similar to the case for ³He@C₆₀ (8.81 ppm upfield shift from free ³He).

Three additional fullerene derivatives, H₂@16, H₂@17, and H₂@18, were synthesized by the Bingel reaction, benzyne addition and Prato reaction in order to further investigate this issue.

To clarify the electronic properties of H₂@C₆₀ in more detail, cyclic voltammetry (CV) and differential pulse voltammetry (DPV), were conducted.

Thus the difference in reduction potential reaches nearly 0.15 V at the stage of six-electron reduction. Although the extent is so minute, this result is taken as clear evidence that hydrogen, as a slightly electro-positive molecule, exerts an appreciable electronic repulsion with the outer C₆₀ cage when the π-system of the latter is charged with more than four electrons.

For the purpose of the present invention, it is noted that an entirely new endohedral fullerene encapsulating molecular hydrogen, H₂@C₆₀ can be synthesized in a macroscopic amount by chemically closing the 13-membered ring orifice of open-cage fullerene 5 incorporating hydrogen. The endohedral chemical shift for the molecular hydrogen is a series of open-cage fullerenes is particularly sensitive to the transformation of the outer cage, and the GIAO and NICS calculations are helpful to rationalize the chemical shift change even for such highly derivatized fullerenes. The endohedral hydrogen's NMR signal of representative derivatives of H₂@C₆₀ has indicated that it can serve as a sensitive probe for exohedral transformation of the fullerene cage.

FIG. 13-FIG. 15 illustrate use of lasers, as is known to those skilled in the art. In FIG. 13, prior art systems, both direct and indirect, are effectively used with the teachings of the present invention.

FIG. 14 and FIG. 15 show clusters of fusion targets, as discussed, which may be directly or indirectly laser treated, including with amplifiers 317.

Although there has been hereinabove described a series of inventions, it should be appreciated that the inventions are limited thereto. That is, the present inventions may suitably comprise, consist of, or consist essentially of the recited elements. Further, the invention illustratively disclosed herein suitably may be practiced in the absence of any element which may occur to those skilled in the art, should be considered to be within the scope of the present invention as defined in the appended claims.

1. A nano-device encapsulating deuterium and tritium.

2. The nano-device of claim 1, further comprising endohedral fullerenes.

3. The nano-device of claim 1, further comprising clusters of endohedral fullerenes.

4. The nano-device of claim 1, further comprising single and multi-walled nanotubes.

5. The nano-device of claim 4, wherein the nanotubes further comprise nano-laser devices.

6. A device for directing energy to nano-devices encapsulating fusible fuels.

7. The device of claim 5, being joined with an ignition chamber, whereby the output of the ignition chamber, such as tritium, is fed into the breeder device.

8. The device of claim 6, said nano-devices encapsulating fusible elements comprising endohedral fullerenes.

9. The reactor of claim 6, said nano-devices encapsulating fusible fuels.

10. The reactor of claim 6, said nano-devices encapsulating fusible fuels comprising single and multi-walled nanotubes.

11. A methodology for ignition of nano-devices using electro-magnetic energy according to claim 1.

12. A methodology for ignition for nano-devices using electromagnetic energy according to claim 5.

13. An inertial confinement fusion process, comprising in combination:
a plurality nano-devices encapsulating deuterium-tritium fuel.

14. The process according to claim 12, further comprising endohedral fullerenes.

15. The process according to claim 12, further comprising at least one of endohedral fullerenes, clusters of endohedral fullerenes.

16. The process according to claim 12, further comprising at least one of single-walled nanotubes, and arrays of single-walled nanotubes.

17. The process according to claim 12, further comprising multi-walled nanotubes.

18. Products by the process of claim 13.

19. Products by the process of claim 14.

20. Products by the process of claim 15.

21. Products by the process of claim 16.

22. A device for producing endohedral fullerenes encapsulating deuterium and tritium.

23. The device of claim 22, further employing carbon ablating in a rich atmosphere of deuterium and tritium to produce endohedral fullerenes encapsulating deuterium and tritium.

24. The device of claim 22, further employing chemical techniques for encapsulating deuterium and tritium to produce endohedral fullerenes encapsulating deuterium and tritium.

25. The device of claim 22, further employing organic chemical techniques for encapsulating deuterium and tritium to produce endohedral fullerenes encapsulating deuterium and tritium.

26. The device of claim 22, further employing CVD techniques for encapsulating deuterium and tritium to produce endohedral fullerenes encapsulating deuterium and tritium.

27. A device for igniting nano-devices encapsulating deuterium and tritium and employing byproducts of the reaction for breeding nano devices encapsulating deuterium and tritium to further continue the fuel ignition and breeding cycle.
